(19) United States
(12) Patent Application Publication
(10) Pub. No.: US 2025/0232424 A1
(43) Pub. Date: Jul. 17, 2025

(54) DETERMINATION OF UNDERCUT SIDEWALLS BASED ON AN IMAGE OF A SEMICONDUCTOR SPECIMEN

(71) Applicant: Applied Materials Israel Ltd., Rehovot (IL)

(72) Inventors: Roman KRIS, Jerusalem (IL); Vadim VERESCHAGIN, Ashdod (IL); Sahar LEVIN, Or-Yehuda (IL); Shreyasi CHAKRABORTY, Kolkata (IN); SunYoung KIM, Seoul (KR); Jiho KIM, Seongnam-si (KR)

(21) Appl. No.: 18/411,009

(22) Filed: Jan. 11, 2024

(51) Int. Cl. G06T 7/00; G06T 7/10; G06T 7/62; G06V 10/764; G06V 20/70

(52) U.S. Cl. CPC G06T 7/0004; G06T 7/10; G06T 7/62; G06V 10/764; G06V 20/70; G06T 2207/20081; G06T 2207/30148

(57) ABSTRACT

There are provided systems and methods comprising obtaining image data informative of a cavity in a semiconductor specimen, wherein the cavity is associated with at least one sidewall, using the image data to determine one or more attributes of at least one area of the image data, wherein the area is informative of at least one of at least part of the sidewall, or one or more elements coupled to the sidewall, and using the one or more attributes to determine data indicative of whether the sidewall is undercut.

### TECHNICAL FIELD

The presently disclosed subject matter relates, in general, to the field of examination of a specimen, and more specifically, to the determination of manufacturing defects, such as undercut, and to the determination of metrology data.

### BACKGROUND

Current demands for high density and performance associated with ultra large-scale integration of fabricated devices require submicron features, increased transistor and circuit speeds, and improved reliability. Such demands require formation of device features with high precision and uniformity, which, in turn, necessitates careful monitoring of the fabrication process, including automated examination of the devices while they are still in the form of semiconductor wafers.

Examination processes are used at various steps during semiconductor fabrication to measure dimensions of the specimens (metrology), and/or to detect manufacturing errors and/or to classify defects on specimens (e.g., Automatic Defect Classification (ADC), Automatic Defect Review (ADR), etc.).

### General Description

In accordance with certain aspects of the presently disclosed subject matter, there is provided a system comprising one or more processing circuitries configured to obtain image data informative of a cavity in a semiconductor specimen, wherein the cavity is associated with a sidewall, use the image data to determine one or more attributes of at least one area of the image data, wherein the area is informative of at least one of at least part of the sidewall, or one or more elements coupled to the sidewall, and use the one or more attributes to determine data indicative of whether the sidewall is undercut.

According to some embodiments, the system is configured to use the data indicative of whether the sidewall is undercut to estimate a dimension of at least part of a bottom part of the cavity, or of an element located at the bottom part of the cavity.

According to some embodiments, the estimate is more accurate than a raw estimate of the dimension of the at least part of the bottom part of the cavity, or of the dimension of the element, which is not based on a determination of the undercut of the sidewall.

According to some embodiments, the cavity is further associated with a second sidewall, wherein, when said data is indicative that the sidewall is undercut, the system is configured to estimate a dimension of at least part of a bottom part of the cavity, or of an element located at the bottom part of the cavity, based on at least one of: an estimate of a distance between a first top point of the sidewall and a second top point of the second sidewall, extracted from the image data, or a width of a segment of the image data, informative of the second sidewall.

According to some embodiments, the cavity is further associated with a second sidewall, wherein the area comprises a first set of points of the area indicative of a first transition in pixel intensity, and a second set of points of the area indicative of a second transition in pixel intensity, wherein the system is configured to use the data indicative of whether the sidewall is undercut to select between (i) and (ii): (i) using the first set of points to estimate, from the image data, a dimension of at least part of a bottom part of the cavity, or of an element located at the bottom part of the cavity; (ii) using the second set of points to estimate, from the image data, a dimension of at least part of a bottom part of the cavity, or of an element located at the bottom part of the cavity.

According to some embodiments, the one or more attributes include data informative of a width of the area, or of a width of a segment in the area.

According to some embodiments, the one or more attributes include data informative of a distance between: a first set of points of the area indicative of a first transition in pixel intensity, and a second set of points of the area indicative of a second transition in pixel intensity.

According to some embodiments, at least one attribute of the one or more attributes depends on a parameter informative of a physical effect induced on an electron beam of an examination tool by the sidewall, in the acquisition of the image data.

According to some embodiments, the one or more attributes include pixel intensity of different segments of the image data.

According to some embodiments, the one or more attributes include data informative of variations of a position of a set of points of the area, along at least one axis, wherein the set of points is indicative of a transition in pixel intensity.

According to some embodiments, the one or more attributes include at least one of: data informative of variations of a signal informative of a derivative of pixel intensity in at least part of the area, or data informative of variations of a signal informative of a derivative of pixel intensity in a region of pixels of the area corresponding to a pixel intensity transition.

According to some embodiments, the system is configured to use the one or more attributes and a classifier to determine data indicative of whether the sidewall is undercut.

According to some embodiments, the classifier has been obtained using a data set comprising, for each given cavity associated with a given sidewall, of a plurality of given cavities: one or more values of the one or more attributes, generated based on given image data informative of the given cavity, and a label indicative of whether the given sidewall is undercut.

According to some embodiments, the one or more attributes include both a first attribute informative of a distance between a first set of points of the area indicative of a first transition in pixel intensity, and a second set of points of the area indicative of a second transition in pixel intensity, and a second attribute informative of variations, along one axis, of the second set of points.

According to some embodiments, for at least one given attribute of the one or more attributes, or for a plurality of given attributes of the attributes: most values of the given attribute, or of the plurality of given attributes, are located in a first space of values for undercut sidewalls, and most values of the given attribute, or of the plurality of given attributes, are located in a second space of values for sidewalls which are not undercut, wherein the first range of values is different from the second range of values.

According to some embodiments, the cavity belongs to a 3D NAND.

In accordance with other aspects of the presently disclosed subject matter, there is provided a method comprising performing, by one or more processing circuitries, the features as described above for the system.

In accordance with other aspects of the presently disclosed subject matter, there is provided a non-transitory computer readable medium comprising instructions that, when executed by one or more processing circuitries, cause the one or more processing circuitries to perform the method described above.

In accordance with other aspects of the presently disclosed subject matter, there is provided a system comprising one or more processing circuitries configured to obtain, for each given cavity of a plurality of given cavities, wherein each given cavity belongs to a given semiconductor specimen and is associated with at least one given sidewall: one or more values for one or more attributes informative of at least one given area of given image data of the given specimen, wherein the given area is informative of at least one of at least part of the given sidewall, or one or more elements coupled to the given sidewall, and a given label indicative of whether the given sidewall is undercut, thereby obtaining a data set, and use the data set to generate a model usable to determine, based on image data of a semiconductor specimen, data indicative of whether a sidewall associated with a cavity of the semiconductor specimen is undercut.

According to some embodiments, the one or more attributes include data informative of a distance between: a first set of points of the given area indicative of a first transition in pixel intensity, and a second set of points of the given area indicative of a second transition in pixel intensity.

According to some embodiments, wherein the one or more attributes include data informative of variations of a position of a set of points of the area, along at least one axis, wherein the set of points is indicative of a transition in pixel intensity.

In accordance with other aspects of the presently disclosed subject matter, there is provided a method comprising performing, by one or more processing circuitries, the features as described above for the system.

In accordance with other aspects of the presently disclosed subject matter, there is provided a non-transitory computer readable medium comprising instructions that, when executed by one or more processing circuitries, cause the one or more processing circuitries to perform the method described above.

In accordance with other aspects of the presently disclosed subject matter, there is provided a non-transitory computer readable medium comprising instructions that, when executed by one or more processing circuitries, cause the one or more processing circuitries to perform obtaining image data informative of a cavity in a semiconductor specimen, wherein the cavity is associated with at least one sidewall, using the image data to determine one or more attributes of at least one area of the image data, wherein the area is informative of at least one of at least part of the sidewall, or one or more elements coupled to the sidewall, and using the one or more attributes to determine data indicative of whether the sidewall is undercut.

According to some examples, the proposed solution enables accurate determination of undercut in a sidewall of a cavity.

According to some examples, the proposed solution enables automatic determination of undercut in a sidewall of a cavity.

According to some examples, the proposed solution provides a more accurate critical dimension (CD) measurement.

According to some examples, the proposed solution provides an accurate critical dimension (CD) measurement of the bottom part of a cavity, even in the presence of an undercut sidewall.

According to some examples, the proposed solution improves yield of the manufacturing process of a specimen.

According to some examples, the proposed solution corrects possible inaccurate measurements of a dimension of an element located at the bottom part of the cavity, or of a dimension of the bottom part itself.

### BRIEF DESCRIPTION OF THE DRAWINGS

In order to understand the disclosure and to see how it may be carried out in practice, embodiments will now be described, by way of non-limiting example only, with reference to the accompanying drawings, in which:

FIG. 1 illustrates a generalized block diagram of an examination system in accordance with certain embodiments of the presently disclosed subject matter.

FIG. 2A illustrates a cross-section of cavity in a specimen, in which the sidewalls of the cavity are not undercut.

FIG. 2B illustrates a schematic view of an image of the cavity of FIG. 2A, acquired by an examination tool.

FIG. 2C illustrates a cross-section of cavity in a specimen, in which the left sidewall is undercut.

FIG. 2D illustrates a schematic view of an image of the cavity of FIG. 2C, acquired by an examination tool.

FIG. 3 illustrates a generalized flow-chart of a method of determining whether a sidewall of a cavity is undercut, based on one or more attributes extracted from an image of the cavity.

FIG. 4A illustrates a first non-limitative example of an attribute which can be used in the method of FIG. 3.

FIG. 4B illustrates a generalized flow-chart of a method enabling determining the first attribute of FIG. 4A.

FIG. 5A illustrates a second non-limitative example of an attribute which can be used in the method of FIG. 3.

FIG. 5B illustrates a generalized flow-chart of a method enabling determining the second attribute of FIG. 5A.

FIG. 6 illustrates a generalized flow-chart of a method of determining presence of an undercut sidewall, based on a classifier.

FIG. 7A illustrates a non-limitative example of attribute values which can be used to differentiate between undercut sidewalls and sidewalls which are not undercut.

FIG. 7B illustrates a non-limitative example of classification of attribute values as corresponding to a sidewall which is not undercut.

FIG. 7C illustrates a non-limitative example of classification of attribute values as corresponding to a sidewall which is undercut.

FIG. 8 illustrates a generalized flow-chart of a method of training/building a classifier to detect undercut sidewalls based on one or more attributes.

FIG. 9A illustrates a generalized flow-chart of a method of determining dimension(s) of an element located at the bottom part of a cavity associated with an undercut sidewall, or of at least part of the bottom part itself.

FIGS. 9B and 9C illustrate non-limitative examples of the method of FIG. 9A.

FIG. 10 illustrates a generalized flow-chart of a method of using detection of an undercut sidewall.

### DETAILED DESCRIPTION OF EMBODIMENTS

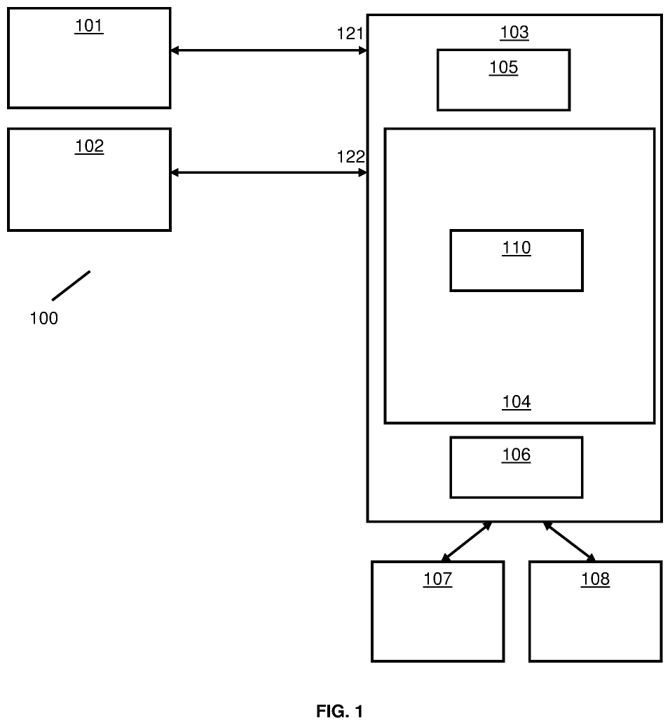

Attention is drawn to FIG. 1 illustrating a functional block diagram of an examination system 100 in accordance with certain examples of the presently disclosed subject matter.

It is noted that the teachings of the presently disclosed subject matter are not bound by the examination system 100 described with reference to FIG. 1. Equivalent and/or modified functionality can be consolidated or divided in another manner, and can be implemented in any appropriate combination of software with firmware and/or hardware and executed on a suitable device. The examination system 100 can be a standalone network entity, or integrated, fully or partly, with other network entities. Those skilled in the art will also readily appreciate that the data repositories can be consolidated or divided in other manner; databases can be shared with other systems or be provided by other systems, including third party equipment. The examination system illustrated in FIG. 1 can be implemented in a distributed computing environment, in which the aforementioned functional modules shown in FIG. 1 can be distributed over several local and/or remote devices, and can be linked through a communication network.

The examination system 100 illustrated in FIG. 1 can be used for examination of a specimen (e.g., of a wafer and/or parts thereof) as part of the specimen fabrication process. The illustrated examination system 100 comprises computer-based system 103 operatively connected to one or more low-resolution examination tools 101 and/or one or more high-resolution examination tools 102 and/or other examination tools. The examination tools are configured to capture images and/or to review the captured image(s) and/or to enable or provide measurements related to the captured image(s).

System 103 includes at least one processing circuitry 104 operatively connected to a hardware-based input interface 105 and to a hardware-based output interface 106. System 103 can be implemented as stand-alone computer(s) to be used in conjunction with the examination tools. Alternatively, the respective functions of the system can, at least partly, be integrated with one or more examination tools.

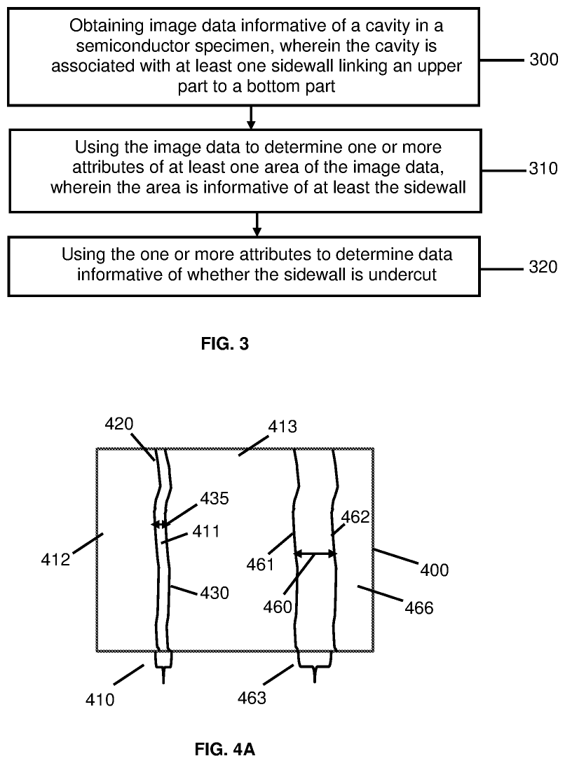

The processing circuitry 104 is configured to provide processing necessary for performing various operations, as further detailed with reference to FIGS. 3, 4B, 5B, 6, 8, 9 and 10.

The processing circuitry 104 can implement at least one classifier 110 (also called a classification model, or a model). Instructions stored in a computer memory can be executed by the processing circuitry 104 to operate the classifier 110. As explained hereinafter, the classifier 110 can be used to determine, based on one or more attributes extracted from an image of a cavity (such as a SEM image), whether at least one sidewall of the cavity is undercut. The classifier 110 can be obtained using methods such as linear regression, logistic regression, binary tree, SVM (Support Vector Machine), etc. This is not limitative.

System 103 is configured to receive, via input interface 105, input data. Input data can include data (and/or derivatives thereof and/or metadata associated therewith) produced by one or more examination tools 101, 102, and/or provided by another computerized system. It is noted that input data can include acquisition signals (resulting from the acquisition of a specimen), simulated acquisition signals (resulting from the simulation of the acquisition of a specimen), synthetic acquisition signals, images (e.g., captured images, images derived from the captured images, simulated images, synthetic images, etc.) and associated numeric data (e.g., metadata, hand-crafted attributes, etc.). It is further noted that image data can include data related to a layer of interest and/or to one or more other layers of the specimen.

System 103 is further configured to process at least part of the received input data and send the results (or part thereof), via the output interface 106, to a storage system 107, and/or to examination tool(s), and/or to a computer-based graphical user interface (GUI) 108 for rendering the results and/or to external systems. This is however not limitative.

By way of non-limiting example, a specimen can be examined by one or more low-resolution examination tools 101 (e.g., an optical inspection system, low-resolution SEM, etc.). The resulting data (image data 121), informative of low-resolution images of the specimen, can be transmitted—directly or via one or more intermediate systems—to system 103. Alternatively, or additionally, the specimen can be examined by a high-resolution machine 102 (e.g., a subset of potential defect locations selected for review can be reviewed by a scanning electron microscope (SEM) or Atomic Force Microscopy (AFM)). The resulting data (high-resolution image data 122), informative of high-resolution images of the specimen, can be transmitted-directly or via one or more intermediate systems—to system 103. In some cases, the same examination tool can provide low-resolution image data and high-resolution image data.

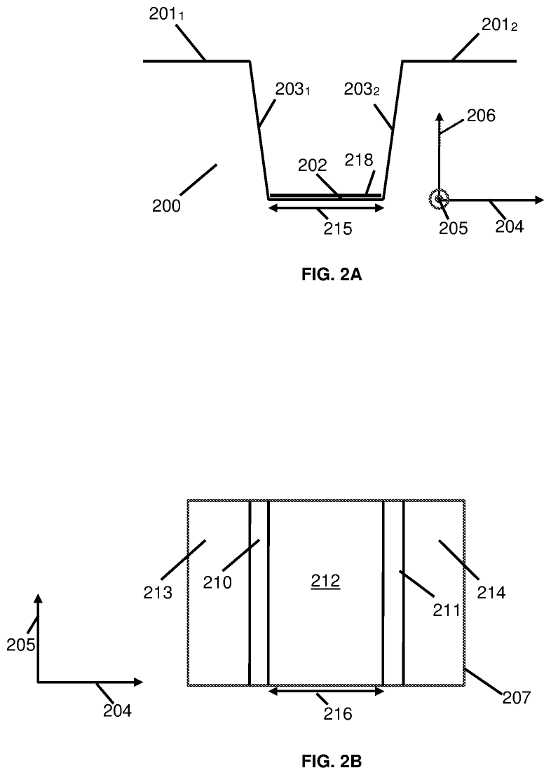

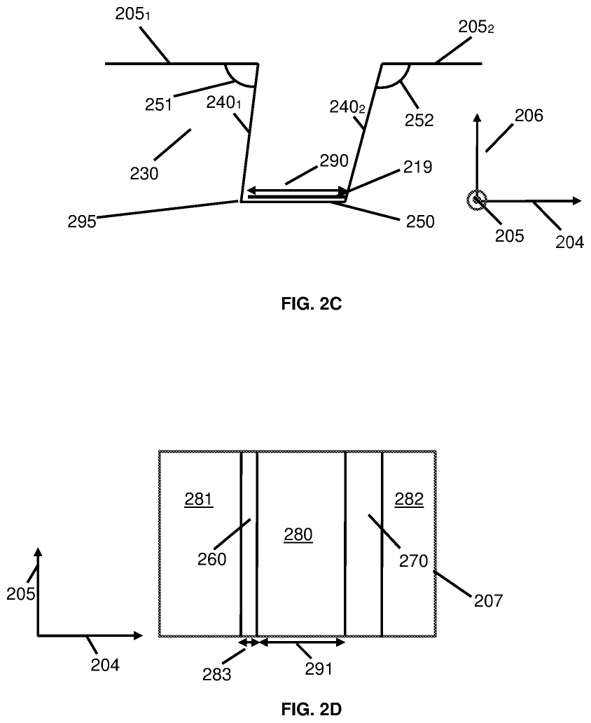

Attention is now drawn to FIGS. 2A and 2B.

FIG. 2A depicts a cross-section of part of a specimen which includes a cavity 200. The cavity is associated with a first sidewall 2031 linking a bottom part 202 of the cavity 200 to an upper part 2011. Assume that a set of three axes is defined: a first axis corresponds to a horizontal axis 204 located in the plane of the specimen, a second axis 205 is orthogonal to the horizontal axis 204 and is also located in the plane of the specimen, and a vertical axis 206 (height axis of the specimen) is orthogonal to axes 204 and 205.

The bottom part 202 of the cavity 200 is located deeper in the specimen (along the vertical axis 206) than the upper part 2011. In this example, the cavity 200 is associated with a second sidewall 2032, which links the bottom part 202 to an upper part 2012. In other words, the cavity is formed between the first sidewall and the second sidewall. Note that this is not limitative, and the cavity could be associated with a single sidewall, which links an upper part to a bottom part (the cavity would correspond in this case to a step, which is formed by the presence of the single sidewall).

The cavity 200 is well manufactured and does not suffer from an undercut of its sidewall(s). Acquisition of the cavity 200 by an examination tool (such as an SEM) provides an image 207 as depicted in FIG. 2B, which includes different segments, associated with different pixel intensities. Segments 210 and 211 correspond respectively to the first sidewall 2031 and to the second sidewall 2032. Segment 212 corresponds to the bottom part 202 of the cavity 200. Segments 213 and 214 correspond respectively to the left upper part 2011 of the cavity and to the right upper part of the cavity 2012.

Attention is now drawn to FIGS. 2C and 2D.

FIG. 2C a cross-section of part of a specimen which includes a cavity 230. The cavity 230 is associated with a first sidewall 2401 linking a bottom part 250 of the cavity 230 to an upper part 2051.

The bottom part 250 of the cavity 230 is located deeper in the specimen (along the vertical axis 206) than the upper part 2051. In this example, the cavity 230 includes a second sidewall 2402, which links the bottom part 250 to an upper part 2052. Note that this is not limitative, and the cavity could include a single sidewall, which links an upper part to a bottom part (the cavity would correspond in this case to a step).

There is a defect in the cavity 230, since the cavity 230 suffers from undercut of the first sidewall 2401. Indeed, the first sidewall 2401 is associated with a negative slope: the angle 251 between the upper part 2051 and the first sidewall 2401 is smaller than 90 degrees (in a vertical plane), such that the extremity 295 of the first sidewall 2401 protrudes below the upper part 2501.

In this example, the second sidewall 2402 of the cavity 230 is well manufactured and does not suffer from undercut, since the angle 252 between the upper part 2052 and the second sidewall 2402 is larger than 90 degrees.

Acquisition of the cavity 230 by an examination tool (such as a SEM) provides an image 207 as depicted in FIG. 2D, which includes different segments, associated with different pixel intensities. Segment 260 corresponds to the region of the first sidewall 2401, segment 280 corresponds to the bottom part 250 of the cavity 230, segment 281 corresponds to the upper part 2051 and segment 282 corresponds to the upper part 2052.

The width 283 of the segment 260 (along the horizontal axis 204) is small, due to the presence of an undercut of the first sidewall 2401.

The bottom part of a cavity can include an element (see reference 218 in FIG. 2A and reference 219 in FIG. 2B). This element can be, for example, a metallic element. In FIG. 2B, in which no undercut is present, the width of the bottom part 202 of the cavity, or the width of the metallic element 218 can be accurately measured by determining the width 216 of the segment 212 in the image 207.

However, in FIG. 2D, if it is intended to measure the width 290 of the metallic element 219 located at the bottom part 250 of the cavity 230 from the SEM images based on a prior-art approach, the presence of an undercut will lead to an error in the measurement. The width 290 of the metallic element 219 located at the bottom part 250 of the cavity cannot be accurately measured by determining the width 291 of the segment 280 in the image 207. Indeed, the actual width 290 of the metallic element 219 is larger than the width 291. A naïve approach, which would ignore the presence of an undercut sidewall and would therefore measure the width 291, would yield to an inaccurate measurement.

Attention is now drawn to FIG. 3, which depicts a non-limitative example of a method of detecting undercut in a sidewall of a cavity.

The method of FIG. 3 includes obtaining (operation 300) image data informative of a cavity in a semiconductor specimen. As explained above with reference to FIGS. 2A to 2D, the cavity is associated with at least one sidewall linking an upper part to a bottom part. The image data can correspond to an image acquired by an examination tool (see references 101, 102 in FIG. 1), such as, but not limited to, a SEM. The image data can include, for each of a plurality of pixels, a corresponding pixel intensity (e.g., grey level intensity).

The method of FIG. 3 further includes using (operation 310) the image data to determine one or more attributes informative of at least one area of the image data. The area is informative of at least part of the sidewall. Note that the area can be informative also of elements coupled to the sidewall, that it to say at least a fraction of the upper part of the cavity (this upper part is coupled to the top extremity of the sidewall) and/or of at least a fraction of the bottom part of the cavity (this bottom part is coupled to the extremity of the sidewall, at its bottom). Different examples of attributes are described hereinafter. The attribute(s) can be selected such that their value differs between an undercut sidewall and a sidewall which is not undercut. This enables identifying the presence of an undercut sidewall.

The method of FIG. 3 further includes using (operation 320) the one or more attributes to determine data informative of whether the sidewall is undercut. This can include a score which is informative of a probability that the sidewall is undercut. When an undercut sidewall is detected, an alarm can be raised to a user.

The method of FIG. 3 (and the other methods described herein) can be used in some examples to detect undercut in a sidewall of a cavity located in a 3D NAND. This enables measuring more accurately the bottom part of the cavity in a 3D NAND. A 3D NAND is a type of non-volatile flash memory in which the memory cells are stacked vertically in multiple layers.

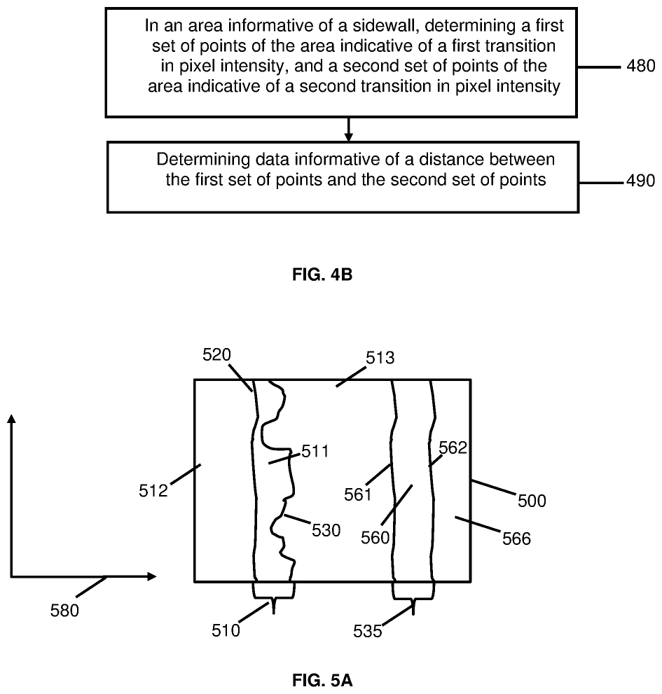

FIG. 4A illustrates a first example of an attribute which can be used in the method of FIG. 3. FIG. 4B illustrates a non-limitative example of a method enabling determining this first attribute.

In the image 400 of the cavity as depicted in FIG. 2C, it is expected that the area 410 informative of the left sidewall includes a sub-area 411 of pixels delimited by a first edge (left edge 420) and a second side (right edge). At the first edge 420, there is a transition (variation) in pixel intensity between the pixel intensity of the adjacent sub-area 412 of pixels (located at the left side of the sub-area 411) and the pixel intensity of the sub-area 411. At the second edge 430, there is a transition (variation) in pixel intensity between the pixel intensity of the sub-area 411 and the pixel intensity of the adjacent sub-area 413 of pixels (located at the right side of the sub-area 411). The transition at the first edge and/or at the second edge can be such that the variation in pixel intensity is above a certain threshold. The transition in pixel intensity can be detected using methods described (for example) in Semiconductor Manufacturing Handbook, McGraw-Hill Handbooks. For example, the pixel intensity of the sub-areas 412 and 466 can tend to the white color, the pixel intensity of the sub-areas 411 and 463 can tend to the dark color, and the pixel intensity of the sub-area 413 can tend to the grey color.

The first edge can include a plurality of pixels. Note that the first edge is not necessarily a straight line and can correspond to a curve linking a plurality of pixels. The same conclusions apply to the second edge.

An attribute that can be used in the method of FIG. 3 includes data informative of a distance between the first edge and the second edge.

In order to compute this attribute, the method of FIG. 4B can include, in an area of the image of the specimen informative of a sidewall, determining (operation 480) a first set of points of the area indicative of a first transition in pixel intensity in the area (the first set of points corresponding to a first edge present in the image), and a second set of points of the area indicative of a second transition in pixel intensity in the area (the second set of points corresponding to a second edge present in the image). The method further includes (operation 490) determining data informative of a distance between the first set of points and the second set of points. In some examples, the minimal distance (or average minimal distance) between the first edge and the second edge is computed and used as an attribute in the method of FIG. 2A.

As mentioned with reference to FIG. 2B, the presence of a small distance between the first edge and the second edge can be indicative of the presence of an undercut. To the contrary, the presence of a large distance tends to indicate that no undercut is present. Therefore, this attribute can be used to determine whether an undercut is present. This is visible in FIG. 4A, in which the distance 435 between the first edge 420 and the second edge 430 is small (in the area 410 informative of an undercut sidewall), whereas the distance 460 between the first edge 461 and the second edge 462 of the area 463 (informative of another sidewall of the cavity, which is not undercut) is large. The first edge 461 and the second edge 462 are opposite edges delimiting a sub-area 463 of pixels. At the first edge 461, there is a transition (variation) in pixel intensity between the pixel intensity of the adjacent sub-area 413 of pixels (located at the left side of the sub-area 463) and the pixel intensity of the sub-area 463. At the second edge 462, there is a transition (variation) in pixel intensity between the pixel intensity of the sub-area 463 and the pixel intensity of the adjacent sub-area 466 of pixels (located at the right side of the sub-area 463). The transition at the first edge and/or at the second edge can be such that the variation in pixel intensity is above a certain threshold.

In some examples, an attribute informative of the distance (noted 8) between the first edge and the second edge is computed and is informative of a parameter (noted P) indicative of a physical effect (such as finite beam width reflection) on the electrons (used to acquire the image of the cavity) by the sidewall. Indeed, the sidewall can cause that the BSE (back-scattered electrons) signal is reflected by the sidewall, and not collected by the detectors of the examination tool. This creates a shadow in the image. This parameter P can be selected by the user. In particular, the following first attribute F₁ can be used:

$${F}_{1} = \frac{δ}{P}$$

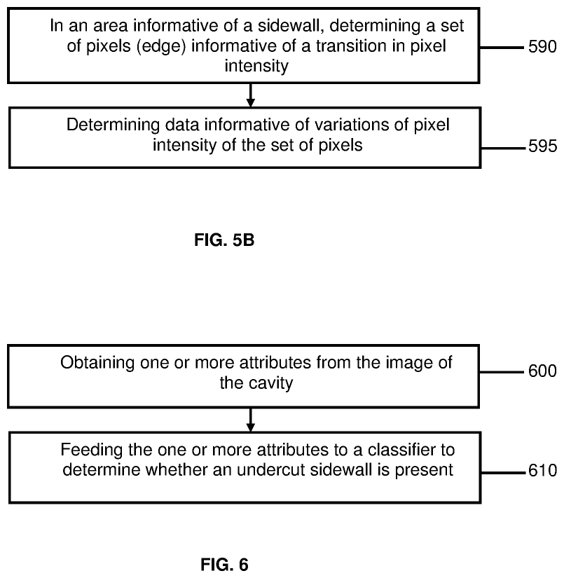

FIG. 5A illustrates a second example of an attribute which can be used in the method of FIG. 3. FIG. 5B illustrates a non-limitative example of a method enabling determining this second attribute.

FIG. 5A depicts an image 500 of a cavity, in which the left sidewall is undercut and the right sidewall is not undercut (such as the cavity depicted in FIG. 2C).

In the image 500 of the cavity, the area 510 is informative of the left sidewall (which is undercut). The area 510 includes a sub-area 511 of pixels delimited by a first set 520 of pixels (left edge 520) and a second set 530 of pixels (right edge 530). At the first edge 520, there is a transition (variation) in pixel intensity between the pixel intensity of the adjacent sub-area 512 of pixels (located at the left side of the sub-area 511) and the pixel intensity of the sub-area 511. At the second edge 530, there is a transition (variation) in pixel intensity between the pixel intensity of the sub-area 511 and the pixel intensity of the adjacent sub-area 513 of pixels (located at the right side of the sub-area 511). The transition at the first edge and/or at the second edge can be such that the variation in pixel intensity is above a certain threshold.

In the image 500 of the cavity, the area 535 is informative of the right sidewall of the cavity (which is not undercut). The area 535 includes a sub-area 560 of pixels delimited by a first set 561 of pixels (left edge 561) and a second set 562 of pixels (right edge 562). At the first edge 520, there is a transition (variation) in pixel intensity between the pixel intensity of the adjacent sub-area 513 of pixels (located at the left side of the sub-area 560) and the pixel intensity of the sub-area 560. At the second edge 562, there is a transition (variation) in pixel intensity between the pixel intensity of the sub-area 560 and the pixel intensity of the adjacent sub-area 566 of pixels (located at the right side of the sub-area 560).

As visible in FIG. 5A, the variations in the position of the second edge 530 (which is located in the area 510 informative of the undercut sidewall) along the horizontal axis 580 are much higher than the other edges. This can be used to differentiate between an area corresponding to an undercut sidewall and an area corresponding to a sidewall which is not undercut.

FIG. 5B depicts a method of computing this second attribute.

The method of FIG. 5B includes determining (operation 590) a set of pixels indicative of a transition in pixel intensity. This set of pixels can correspond, e.g., to the second edge 530 (or to the other edges 520, 561 or 562).

When there is an undercut, the variations in the derivative of the pixel intensity (grey level signal) of the edge (e.g., along the horizontal axis) are high. This is visible in FIG. 5A, in which the variations in the position of the edge 530 are large along the horizontal axis. As a consequence, the variations in the derivative of the pixel intensity of the edge 530 are large along the horizontal axis 580.

Conversely, when there is no undercut, the variations in the derivative of the pixel intensity (grey level signal) of the edge (e.g., along the horizontal axis) are small. This is visible in FIG. 5A, in which the variations in the derivative of the pixel intensity of the edge 561 are small along the horizontal axis 580.

The method of FIG. 5B can therefore further include determining data informative of variations of a position (e.g., along the horizontal axis) of the set of pixels determined at operation 590. This can include determining (operation 595) data informative of variations in a derivative signal of the pixel intensity signal of the set of pixels (edge determined at operation 590). In particular, the pixel intensity signal of the edge along the horizontal axis can be extracted from the image, and its derivative can be computed. The standard deviation of the derivative signal can be computed. A high standard deviation indicates high variations, whereas a small standard deviation indicates small variations.

In some examples, data informative of variations in the derivative signal of the pixel intensity signal of the set of pixels can be normalized. In some examples, the average (mean) of the derivative signal can be used to normalize the signal. In some examples, the following second attribute can be used:

$${F}_{2} = \frac{std ( derivative )}{mean ( derivative )}$$

In this equation, the standard deviation of the derivative signal (of the pixel intensity is the edge) is divided by the mean of the derivative signal, for normalization purpose. For the edge 530, a large value is obtained, whereas for the edges 520, 561, and 562 a small value is obtained. Therefore, this second attribute can be used to differentiate between an undercut sidewall and a sidewall which is not undercut.

The various attributes described above are only examples, and additional attributes can be used.

In some examples, the one or more attributes can include pixel intensity of different segments of the image data. Each segment is associated with a different range of pixel intensity. The average pixel intensity of each segment of the plurality of segments can be used as attributes. In the example of FIG. 2D, the pixel intensity of the different segments 281, 260, 280, and 270 can be used as attributes. In the example of FIG. 4A, the pixel intensity of the different segments 412, 411, 413, and 463 can be used as attributes. This is not limitative.

Attention is now drawn to FIG. 6.

As explained above, various attributes can be computed based on the image of the cavity. The method of FIG. 6 uses one or more of these attributes to determine whether an undercut is present.

The method of FIG. 6 includes obtaining (operation 600) one or more attributes extracted from an image of the cavity, as explained above.

The method of FIG. 6 further includes feeding (operation 610) the one or more attributes to a classifier (also called model). The classifier is for example a trained classifier. The classifier may have been trained beforehand based on numerous examples of attributes extracted from images of undercut sidewalls and of non-undercut sidewalls.

The classifier can output, or can be used to generate, a score indicative of the probability that a sidewall of the cavity is undercut. Note that if the cavity includes two sidewalls, the classifier can output a different score for each sidewall. If the score is above or equal to a threshold, it can be concluded that the sidewall is undercut. If the score is below the threshold, it can be concluded that the sidewall is not undercut.

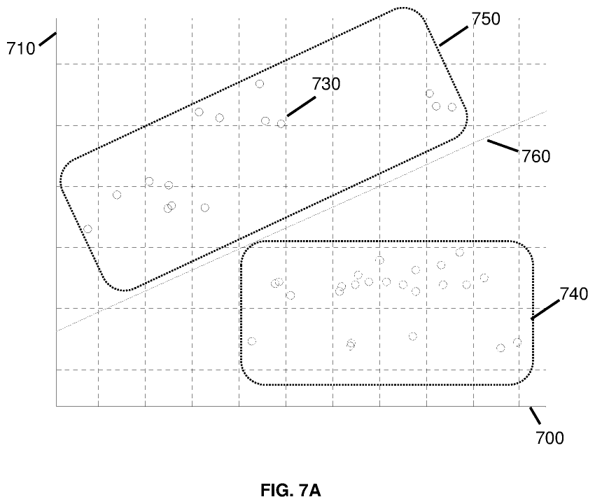

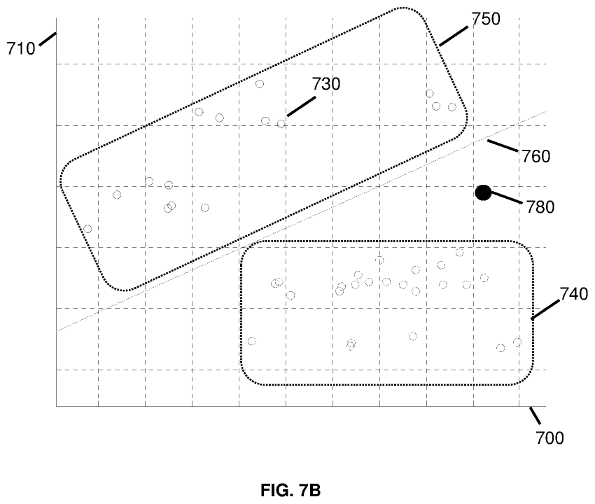

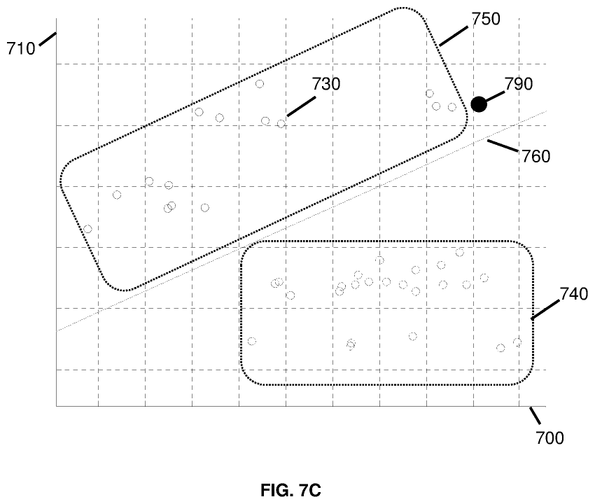

FIG. 7A illustrates a non-limitative example of attribute values which can be used to build a classifier (also called model) usable in the method of FIG. 6.

In FIG. 7A, the horizontal axis 700 of the graph corresponds to the value of the first attribute F₁ and the vertical axis 710 of the graph corresponds to the value of the second attribute F₂. A plurality of points 730 are plotted in the graph. For each given point, the abscissa of the given point corresponds to the value of the first attribute F₁, and the ordinate value of the given point corresponds to the value of the second attribute F₂. The plurality of points may have been collected by determining the values of the first and second attributes in image(s) of one or more cavities. According to some examples, some of these cavities include an undercut sidewall, and some of these cavities do not include an undercut sidewall. Each point of the graph corresponds to the attribute values extracted from the image of a given sidewall.

In the graph of FIG. 7A, the subset 750 of points corresponds to attributes values associated with an undercut sidewall. The subset 740 of points corresponds to attributes values associated with a sidewall which is not undercut. As visible in FIG. 7A, the line 760 delineates between the subset 740 of points and the subset 750 of points.

During building/training of the classifier, the coefficients of the function 760 (in this case, a linear function—note that this is not limitative) can be determined.

During usage of the classifier (see FIG. 6), when a new point (associated with a first value for the first attribute and a second value for the second attribute) is obtained, the function can be used to determine whether it corresponds to an undercut sidewall, or to a sidewall which is not undercut.

In FIG. 7B, a new point 780 is obtained. The new point 780 includes attributes extracted from the image of a sidewall. Since the new point 780 is located below the function 760, the classifier concludes that the sidewall is not undercut.

In FIG. 7C, a new point 790 is obtained. The new point 790 includes attributes extracted from the image of a sidewall. Since it is located above the function 760, the classifier concludes that the sidewall is undercut.

Note that although FIGS. 7A to 7C illustrate building of a classifier with two attributes, it has to be noted that a single attribute can be used, or more than two attributes can be used.

The attribute(s) can be selected such that they enable differentiating between undercut sidewalls and sidewalls which are not undercut. In some examples, for a given attribute, most values of the given attribute are located in a first space of values for undercut sidewalls, and most values of the given attribute are located in a second space of values (different from the first space of values) for sidewalls which are not undercut. This enables differentiating between undercut sidewalls and sidewalls which are not undercut.

In some examples in which a plurality of given attributes is used, most values of the plurality of given attributes are located in a first space of values for undercut sidewalls, and most values of the plurality of given attributes are located in a second space of values (different from the first space of values) for sidewalls which are not undercut. This is visible in FIG. 7A, in which the first space corresponds to reference 750 and the second space corresponds to reference 740.

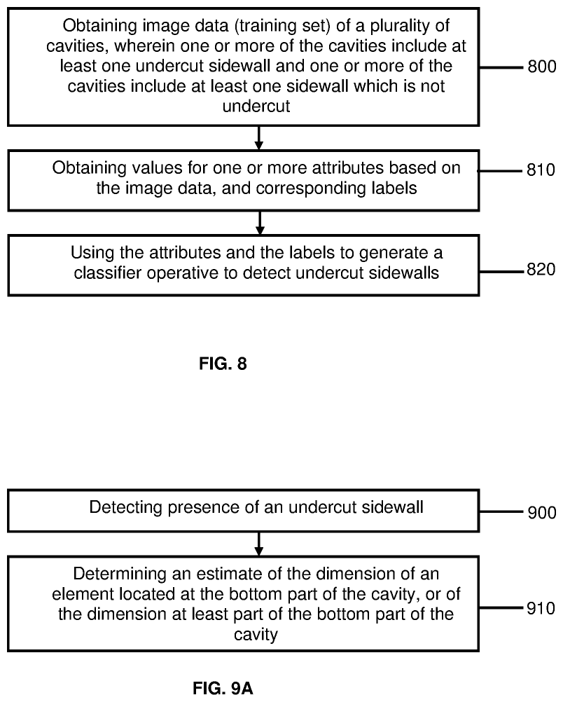

FIG. 8 describes a method of building/training a classifier (also called model).

The method of FIG. 8 includes obtaining (operation 800) image data (training set) of a plurality of cavities. One or more of the cavities include at least one undercut sidewall (positive samples). One or more of the cavities include at least one sidewall which is not undercut (negative samples). In the training set, it is known which cavities include an undercut sidewall and which cavities do not.

The method of FIG. 8 includes determining (operation 810) attribute(s) for the image data obtained at operation 800. For example, for each image, depending on the number N of attributes (e.g., N equal to or larger than 1), a corresponding value is obtained. A vector of N values (for the N attributes) is obtained for each image. In some examples, for each sidewall in the image, a vector of N values (for the N attributes) is obtained. Each vector can be labelled: the label indicates whether the sidewall corresponds to an undercut sidewall or to a sidewall which is not undercut.

The method of FIG. 8 further includes using (operation 820) the vectors together with the labels to obtain a classifier. Operation 820 can include building or training a classifier based on the vectors (attribute values) and the labels. One objective of the training is to enable the trained classifier to receive attribute(s) extracted from image data of a cavity, and to output a score informative of whether an undercut sidewall is present.

Different types of training methods and different types of classifiers can be used to train the classifier based on the attribute values and the labels. Non-limitative examples include: linear regression, logistic regression, binary tree, SVM (Support Vector Machine), or any other classification algorithm. This enables obtaining a model or a function which can be used to predict whether an undercut sidewall is present, based on value(s) of attribute(s) extracted from the image (e.g., SEM image) of the sidewall.

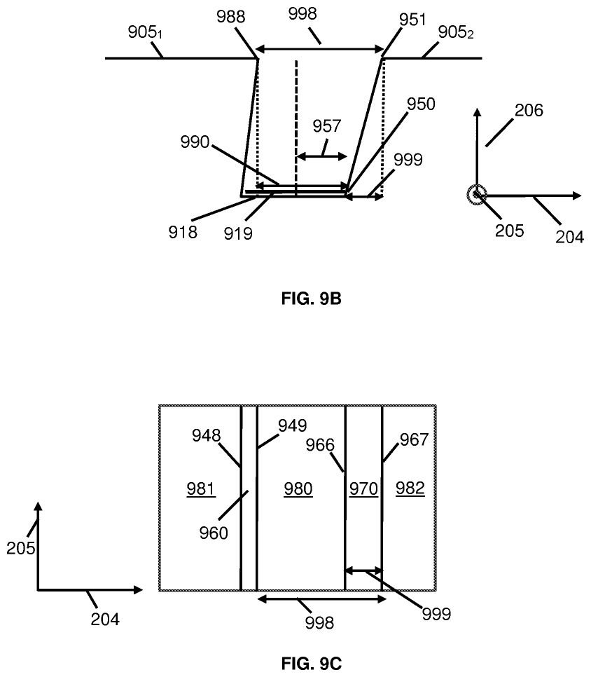

Attention is now drawn to FIGS. 9A and 9B.

Assume that the presence of an undercut sidewall has been identified (operation 900), based on the various methods described herein.

As explained with reference to FIGS. 2C and 2D, a naïve measurement of the dimension (see dimension 291) of the element located at the bottom part of the cavity, which ignores the presence of an undercut sidewall, yields to an inaccurate estimate.

Since the presence of an undercut sidewall has been detected, this inaccurate estimate can be avoided. In particular, an estimate of the dimension of the element located at the bottom part of the cavity (or of a dimension of at least part of the bottom part itself) can be determined, which is more accurate than a raw estimate which would be based on an assumption that ignores the presence of an undercut sidewall (that is to say a prior-art method).

The method of FIG. 9A further includes (operation 910) determining an estimate of the dimension (width) of the element located at the bottom part of the cavity (or determining an estimate of the dimension of at least part of the bottom part of the cavity). This estimate relies on the knowledge that one sidewall of the cavity is undercut, and therefore, avoids using an erroneous measurement.

A non-limitative example of a formula that can be used is provided hereinafter, with reference to FIGS. 9B and 9C.

In this example, the left sidewall is undercut, but the right sidewall is not undercut. The distance between the top point 988 of the left sidewall and the top point 951 of the right sidewall is noted 998.

The corresponding image (depicted in FIG. 9C) includes a segment 970 which is informative of the area between the top point 951 of the right sidewall and the bottom point 950 of the right sidewall, a segment 980 which is informative of the part of the bottom cavity between the lower point 950 of the right sidewall, and a point 918 located at the same horizontal coordinate as the top point 988 of the left sidewall along the horizontal axis 204. The image further includes a segment 960 corresponding to the area of the left sidewall (which is undercut), a segment 981 corresponding to the top left part 9051 and a segment 982 corresponding to the top right part 9052.

The segment 970 is located between two edges: a first edge 966 corresponding to a pixel intensity transition between the segment 970 and the segment 980 and a second edge 967 corresponding to a pixel intensity transition between the segment 970 and the segment 982. The segment 970 has a width 999.

The segment 960 is located between two edges: a first edge 948 corresponding to a pixel intensity transition between the segment 981 (corresponding to the top part 9051) and the segment 960 and a second edge 949 corresponding to a pixel intensity transition between the segment 960 and the segment 980.

The dimension 990 of the element 919 located at the bottom part of the cavity (and extending underneath the undercut sidewall) can be estimated using the following formula (this is not limitative):

$$\frac{1}{2} {CD}_{bottom} = \frac{1}{2} {CD}_{top} - {CD}_{W} ↔ {CD}_{bottom} = {CD}_{top} - 2 {CD}_{W}$$

In this equation, CD_{bottom} corresponds to the width 990, CDₜₒₚ corresponds to the width 998, CD_{W} corresponds to the width 999, and ½CD_{bottom} corresponds to the width 957.

Note that this formula can be also used to determine a more accurate measurement of (at least part) of the bottom part of the cavity.

According to some examples, another estimate can be used. Detection of the presence of an undercut sidewall can be used to determine whether the estimate of the dimension of the element 919 (or of the bottom part of the cavity) should rely on the first edge 948 or on the second edge 949.

If no undercut is detected, the second edge 949 can be used: the distance between the second edge 949 and the edge 966 can be determined to estimate the dimension of the element, or of the bottom part of the cavity).

If an undercut has been detected, the first edge 948 can be used. The dimension 990 of the element 919 can be estimated as the distance (width) between the first edge 966 and the first edge 948. This is more accurate than a naïve estimate which does not detect the presence of undercut sidewalls and would use the width 979 of the segment 980. This method can be used also to determine a more accurate measurement of the dimension of the bottom part of the cavity.

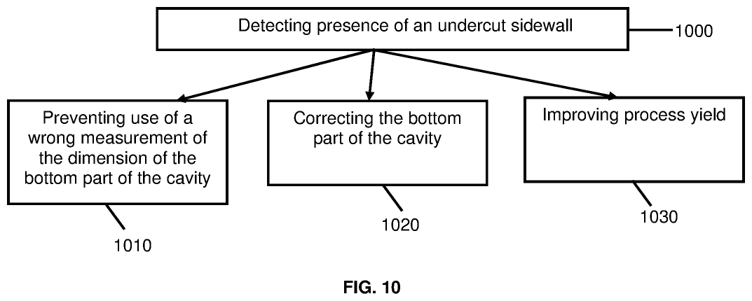

Attention is now drawn to FIG. 10.

Once an undercut sidewall has been detected (operation 1000), this detection can be used for various purposes. Non-limitative examples are provided hereinafter.

In some examples, this can be used to prevent use of a wrong measurement of the dimension of the bottom part of the cavity (operation 1010).

In some examples, this can be used to correct the bottom part of the cavity. In particular, the cavity can be further manufactured (operation 1020).

In some examples, this can be used to improve process yield (operation 1030). In particular, this can be used to prevent a specimen, in which an undercut sidewall is present, to be further used in the manufacturing process. For example, this can be used to prevent that the specimen with an undercut sidewall will be used in the final chip.

In the present description, numerous specific details are set forth in order to provide a thorough understanding of the disclosure. However, it will be understood by those skilled in the art that the presently disclosed subject matter may be practiced without these specific details. In other instances, well-known methods, procedures, components, and circuits have not been described in detail so as not to obscure the presently disclosed subject matter.

Unless specifically stated otherwise, it is appreciated that throughout the specification discussions utilizing terms such as “obtaining”, “using”, “determining”, “performing”, “training”, or the like, refer to the action(s) and/or process(es) of at least one processing circuitry that manipulates and/or transforms data into other data, said data represented as physical, such as electronic, quantities, and/or said data representing the physical objects.

The term “specimen” used in this specification should be expansively construed to cover any kind of wafer, masks, and other structures, combinations and/or parts thereof used for manufacturing semiconductor integrated circuits, magnetic heads, flat panel displays, and other semiconductor-fabricated articles.

The term “examination” used in this specification should be expansively construed to cover any kind of metrology-related operations, as well as operations related to detection and/or classification of defects in a specimen during its fabrication. Examination is provided by using non-destructive examination tools during or after manufacture of the specimen to be examined. By way of non-limiting example, the examination process can include runtime scanning (in a single or in multiple scans), sampling, reviewing, measuring, classifying, and/or other operations provided with regard to the specimen or parts thereof, using the same or different inspection tools. Likewise, examination can be provided prior to manufacture of the specimen to be examined, and can include, for example, generating an examination recipe(s) and/or other setup operations. It is noted that, unless specifically stated otherwise, the term “examination”, or its derivatives used in this specification, is not limited with respect to resolution or size of an inspection area. A variety of non-destructive examination tools includes, by way of non-limiting example, scanning electron microscopes, atomic force microscopes, optical inspection tools, etc.

The processing circuitry 104 can comprise, for example, one or more processors operatively connected to one or more computer memories loaded with executable instructions for executing operations, as further described below. The processing circuitry encompasses a single processor or multiple processors, which may be located in the same geographical zone, or may, at least partially, be located in different zones, and may be able to communicate together.

The one or more processors referred to herein can represent one or more general-purpose processing devices such as a microprocessor, a central processing unit, or the like. More particularly, a given processor may be one of: a complex instruction set computing (CISC) microprocessor, a reduced instruction set computing (RISC) microprocessor, a very long instruction word (VLIW) microprocessor, a processor implementing other instruction sets, or a processor implementing a combination of instruction sets. The one or more processors may also be one or more special-purpose processing devices such as an application specific integrated circuit (ASIC), a field programmable gate array (FPGA), a digital signal processor (DSP), a network processor, or the like. The one or more processors are configured to execute instructions for performing the operations and steps discussed herein.

The memories referred to herein can comprise one or more of the following: internal memory, such as, e.g., processor registers and cache, etc., main memory such as, e.g., read-only memory (ROM), flash memory, dynamic random access memory (DRAM) such as synchronous DRAM (SDRAM) or Rambus DRAM (RDRAM), etc.

It is to be noted that while the present disclosure refers to the processing circuitry 104 being configured to perform various functionalities and/or operations, the functionalities/operations can be performed by the one or more processors of the processing circuitry 104 in various ways. By way of example, the operations described hereinafter can be performed by a specific processor, or by a combination of processors. The operations described hereinafter can thus be performed by respective processors (or processor combinations) in the processing circuitry 104, while, optionally, at least some of these operations may be performed by the same processor. The present disclosure should not be limited to be construed as one single processor always performing all the operations.

It is appreciated that, unless specifically stated otherwise, certain features of the presently disclosed subject matter, which are described in the context of separate embodiments, can also be provided in combination in a single embodiment. Conversely, various features of the presently disclosed subject matter, which are described in the context of a single embodiment, can also be provided separately, or in any suitable sub-combination. In the following detailed description, numerous specific details are set forth in order to provide a thorough understanding of the methods and apparatus.

In embodiments of the presently disclosed subject matter, fewer, more, and/or different stages than those shown in the methods of FIGS. 3, 4B, 5B, 6, 8, 9 and 10 may be executed. In embodiments of the presently disclosed subject matter, one or more stages illustrated in the methods of FIGS. 3, 4B, 5B, 6, 8, 9 and 10 may be executed in a different order, and/or one or more groups of stages may be executed simultaneously.

It is to be understood that the invention is not limited in its application to the details set forth in the description contained herein or illustrated in the drawings.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

What is claimed is:

1. A system comprising one or more processing circuitries configured to:
obtain image data informative of a cavity in a semiconductor specimen, wherein the cavity is associated with a sidewall,
use the image data to determine one or more attributes of at least one area of the image data, wherein the area is informative of at least one of:
at least part of the sidewall, or
one or more elements coupled to the sidewall, and
use the one or more attributes to determine data indicative of whether the sidewall is undercut.

2. The system of claim 1, configured to use the data indicative of whether the sidewall is undercut to estimate a dimension of at least part of a bottom part of the cavity, or of an element located at the bottom part of the cavity.

3. The system of claim 2, wherein said estimate is more accurate than a raw estimate of the dimension of the at least part of the bottom part of the cavity, or of the dimension of the element, which is not based on a determination of the undercut of the sidewall.

4. The system of claim 1, wherein the cavity is further associated with a second sidewall, wherein, when said data is indicative that the sidewall is undercut, the system is configured to estimate a dimension of at least part of a bottom part of the cavity, or of an element located at the bottom part of the cavity, based on at least one of:
an estimate of a distance between a first top point of the sidewall and a second top point of the second sidewall, extracted from the image data;
a width of a segment of the image data, informative of the second sidewall.

5. The system of claim 1, wherein the cavity is further associated with a second sidewall, wherein the area comprises a first set of points of the area indicative of a first transition in pixel intensity, and a second set of points of the area indicative of a second transition in pixel intensity, wherein the system is configured to use the data indicative of whether the sidewall is undercut to select between (i) and (ii): (i) using the first set of points to estimate, from the image data, a dimension of at least part of a bottom part of the cavity, or of an element located at the bottom part of the cavity; (ii) using the second set of points to estimate, from the image data, a dimension of at least part of a bottom part of the cavity, or of an element located at the bottom part of the cavity.

6. The system of claim 1, wherein the one or more attributes include data informative of a width of the area, or of a width of a segment in the area.

7. The system of claim 1, wherein the one or more attributes include data informative of a distance between:
a first set of points of the area indicative of a first transition in pixel intensity, and
a second set of points of the area indicative of a second transition in pixel intensity.

8. The system of claim 1, wherein at least one attribute of the one or more attributes depends on a parameter informative of a physical effect induced on an electron beam of an examination tool by the sidewall, in the acquisition of the image data.

9. The system of claim 1, wherein the one or more attributes include pixel intensity of different segments of the image data.

10. The system of claim 1, wherein the one or more attributes include data informative of variations of a position of a set of points of the area, along at least one axis, wherein the set of points is indicative of a transition in pixel intensity.

11. The system of claim 1, wherein the one or more attributes include at least one of: data informative of variations of a signal informative of a derivative of pixel intensity in at least part of the area, or data informative of variations of a signal informative of a derivative of pixel intensity in a region of pixels of the area corresponding to a pixel intensity transition.

12. The system of claim 1, configured to use the one or more attributes and a classifier to determine data indicative of whether the sidewall is undercut.

13. The system of claim 12, wherein the classifier has been obtained using a data set comprising, for each given cavity associated with a given sidewall, of a plurality of given cavities:
one or more values of the one or more attributes, generated based on given image data informative of the given cavity;
a label indicative of whether the given sidewall is undercut.

14. The system of claim 1, wherein the one or more attributes include both:
a first attribute informative of a distance between a first set of points of the area indicative of a first transition in pixel intensity, and a second set of points of the area indicative of a second transition in pixel intensity, and
a second attribute informative of variations, along one axis, of the second set of points.

15. The system of claim 1, wherein, for at least one given attribute of the one or more attributes, or for a plurality of given attributes of the attributes:
most values of the given attribute, or of the plurality of given attributes, are located in a first space of values for undercut sidewalls, and
most values of the given attribute, or of the plurality of given attributes, are located in a second space of values for sidewalls which are not undercut, wherein the first range of values is different from the second range of values.

16. The system of claim 1, wherein the cavity belongs to a 3D NAND.

17. A system comprising one or more processing circuitries configured to:
obtain, for each given cavity of a plurality of given cavities, wherein each given cavity belongs to a given semiconductor specimen and is associated with at least one given sidewall:
one or more values for one or more attributes informative of at least one given area of given image data of the given specimen, wherein the given area is informative of at least one of:
at least part of the given sidewall,
or one or more elements coupled to the given sidewall, and
a given label indicative of whether the given sidewall is undercut, thereby obtaining a data set, and
use the data set to generate a model usable to determine, based on image data of a semiconductor specimen, data indicative of whether a sidewall associated with a cavity of the semiconductor specimen is undercut.

18. The system of claim 17, wherein the one or more attributes include data informative of a distance between:
a first set of points of the given area indicative of a first transition in pixel intensity, and
a second set of points of the given area indicative of a second transition in pixel intensity.

19. The system of claim 17, wherein the one or more attributes include data informative of variations of a position of a set of points of the area, along at least one axis, wherein the set of points is indicative of a transition in pixel intensity.

20. A non-transitory computer readable medium comprising instructions that, when executed by one or more processing circuitries, cause the one or more processing circuitries to perform:
obtaining image data informative of a cavity in a semiconductor specimen, wherein the cavity is associated with at least one sidewall,
using the image data to determine one or more attributes of at least one area of the image data, wherein the area is informative of at least one of:
at least part of the sidewall, or
one or more elements coupled to the sidewall, and
using the one or more attributes to determine data indicative of whether the sidewall is undercut.
